(19) United States
(12) Patent Application Publication
(10) Pub. No.: US 2017/0214627 A1
(43) Pub. Date: Jul. 27, 2017

(54) Distributed Load Balancing for Network Service Function Chaining

(71) Applicant: Futurewei Technologies, Inc., Plano, TX (US)

(72) Inventors: Hong Zhang, Palo Alto, CA (US); Henry Fourie, Livermore, CA (US)

(21) Appl. No.: 15/409,009

(22) Filed: Jan. 18, 2017

Related U.S. Application Data
(60) Provisional application No. 62/281,575, filed on Jan. 21, 2016.

(51) Int. Cl. H04L 12/833; H04L 29/12

(52) U.S. Cl. CPC H04L 47/31; H04L 61/6022

(57) ABSTRACT

An upstream service function forwarder (SFF) node including a receiver configured to receive a packet, a processor operably coupled to the receiver and configured to implement a load distribution function (LDF), wherein the LDF is configured to select one of a plurality of service functions (SFs) of a same type on a downstream SFF node to process the packet, and a transmitter operably coupled to the processor and configured to transmit the packet to the downstream SFF node for processing by the one of the plurality of SFs selected.

### CROSS-REFERENCE TO RELATED APPLICATIONS

The present application claims priority to U.S. Provisional Patent Application 62/281,575 filed Jan. 21, 2016, by Hong Zhang, et al., entitled “Distributed Load Balancing For Network Service Function Chaining,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A service function chain is composed of a sequence of service function instances that reside on various service nodes. A service node may be, for example, a hardware appliance or a software module running on a virtual machine (VM). Each service function instance (e.g., a firewall, Network Address Translation (NAT), etc.), applies a treatment to the packets arriving at the service node and then forwards the packets on to the next service node for treatment.

### SUMMARY

In an embodiment, the disclosure includes an upstream service function forwarder (SFF) node including a receiver configured to receive a packet, a processor operably coupled to the receiver and configured to implement a load distribution function (LDF), wherein the LDF is configured to select one of a plurality of service functions (SFs) of a same type on a downstream SFF node to process the packet, and a transmitter operably coupled to the processor and configured to transmit the packet to the downstream SFF node for processing by the one of the plurality of SFs selected.

In an embodiment, the upstream SFF node is immediately upstream of the downstream SFF node. In an embodiment, the plurality of SFs is disposed within a service function group (SFG) on the downstream SFF node, and wherein the SFG extends over the downstream SFF node and at least one additional downstream SFF node. In an embodiment, the processor is configured to add a selector to the packet to identify the one of the plurality of SFs selected on the downstream SFF node. In an embodiment, the processor is configured to add the selector to a destination media access control (MAC) address of the packet. In an embodiment, the processor is configured to add metadata to a service chain header of the packet that may be used by the downstream SFF node to determine the one of the plurality of SFs selected. In an embodiment, the selector is added to a type-length-value (TLV) field in a service chain header of the packet. In an embodiment, the plurality of SFs is disposed within a service function group (SFG) on the downstream SFF node, and wherein the LDF is configured with an address of the downstream SFF node used to reach the plurality of SFs in the SFG. In an embodiment, the plurality of SFs is disposed within a service function group (SFG) on the downstream SFF node, and wherein the LDF is configured with a relative weighting of each SF in the plurality of SFs in the SFG. In an embodiment, the LDF is configured with a hashing algorithm and is configured to recognize fields in the packet to be used for hashing. In an embodiment, the upstream SFF node is one of a switch and a router.

In an embodiment, the disclosure includes a downstream service function forwarder (SFF) node including a receiver configured to receive a packet from an upstream SFF node, a processor operably coupled to the receiver and configured to parse the packet to identify one of a plurality of SFs of an equivalent functionality from within a service function group (SFG) selected by a load distribution function (LDF) of the upstream SFF, and apply the one of a plurality of SFs identified to the packet, and a transmitter operably coupled to the processor and configured to transmit the packet after the one of the plurality of SFs has been applied to the packet.

In an embodiment, the SFG encompasses the downstream SFF node and at least one additional downstream SFF node. In an embodiment, the packet contains a selector that identifies the one of the plurality of SFs selected, and wherein the selector is included within a destination media access control (MAC) address of the packet or metadata in a service chain header of the packet. In an embodiment, the packet contains a selector used by the downstream SFF node to determine a next one of the SFs from the plurality of SFs. In an embodiment, each SF in the plurality of SFs in the SFG has been assigned a relative weighting by the LDF of the upstream SFF node.

In an embodiment, the disclosure includes a method of distributed load balancing implemented on an upstream service function forwarder (SFF) node including receiving a packet, selecting one of a plurality of service functions (SFs) of an equivalent functionality from within a service function group (SFG) disposed on at least one downstream SFF node using a load distribution function (LDF), adding a selector to the packet to identify the one of a plurality of SFs selected, and transmitting the packet to the downstream SFF node for processing by the one of the plurality of SFs selected after the selector has been added to the packet.

In an embodiment, the method further includes considering a relative weighting of each SF in the SFG prior to selecting the one of a plurality of SFs. In an embodiment, the method further includes hashing a field in the packet in order to select the one of a plurality of SFs, and wherein the selector is added to a type-length-value (TLV) field in a service chain header of the packet. In an embodiment, the selector is a SF Selector (SFS) added to a service chain header of the packet.

In some embodiments, a balancing mechanism is used in an SFF node to balance distributed load. The balancing mechanism can comprise a receiver to receive a packet, a selector to select one of a plurality of service functions (SFs) of an equivalent functionality from a service function group (SFG) disposed on at least one downstream SFF node using a load distribution function (LDF), a updater to add a selector to the packet to identify the one of a plurality of SFs selected, and a transmitter to transmit the packet to the downstream SFF node for processing by the one of the plurality of SFs selected after the selector has been added to the packet.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a service function chaining architecture.

FIG. 2 is a schematic diagram illustrating the flow of a packet having a service chain header through a service function chaining architecture.

FIG. 3 is a schematic diagram of a packet having a service chain header.

FIG. 4 is an embodiment of a service function chaining architecture using a load distribution function (LDF) on an upstream service function forwarder (SFF) node to select a service function (SF) of a same type from within a service function group (SFG) on a downstream SFF node.

FIG. 5 is another embodiment a service function chaining architecture using a LDF on an upstream SFF node to select a SF of a same type from within a SFG that extends over more than one downstream SFF node.

FIG. 6 is an embodiment of a service function chaining architecture using a LDF on an upstream SFF node to add a SF selector (SFS) to a packet to indicate the selection of the SF of a same type on one of the downstream SFF nodes.

FIG. 7 is an embodiment of a schematic diagram of a packet having a service chain header containing the SFS.

FIG. 8 is a schematic diagram of an embodiment of a network device.

FIG. 9 is an embodiment of a method of distributed load balancing implemented on an upstream SFF node.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

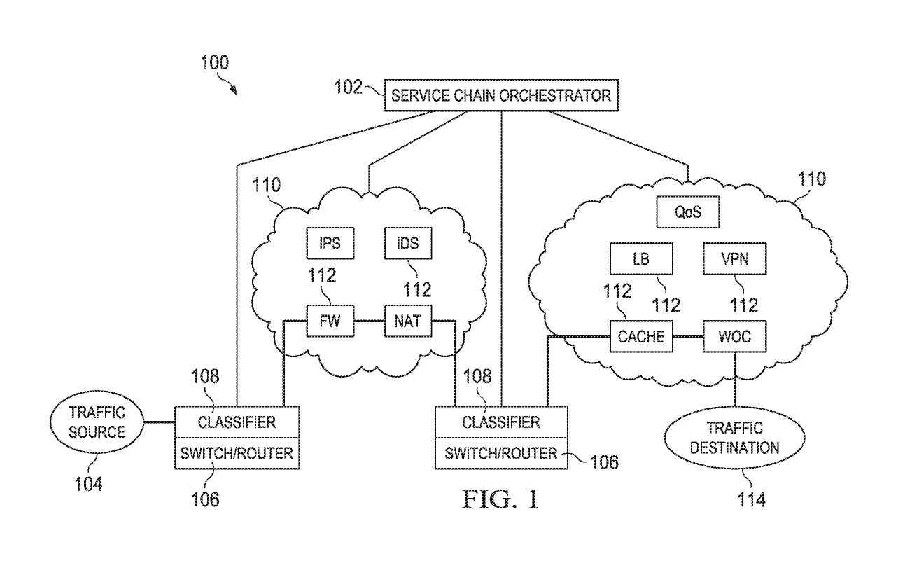

FIG. 1 is a schematic diagram of service function chaining architecture 100. As shown, the service function chaining architecture 100 includes service chain orchestrator 102, a traffic source 104, network devices 106 having a classifier 108, service nodes 110 containing a variety of different service functions 112, and a traffic destination 114. The service chain orchestrator 102, traffic source 104, network devices 106, and service nodes 110 may communicate through wired connections, wireless connections, or some combination thereof Those skilled in the art will appreciate that other devices and/or elements may be included in the service function chaining architecture 100 in practical applications. However, for the sake of brevity, these additional devices and/or elements will not be described in detail.

The service chain orchestrator 102 is a management entity configured to facilitate the application of various service functions to a packet (e.g., data packet, etc.) passing through the service function chaining architecture 100. In other words, the service chain orchestrator 102 manages the creation of service chains (i.e., chains of service functions, as will be discussed more fully below) and sets up the classifiers 108. The service chain orchestrator 102 may be, for example, a server (e.g., a rack server), a software-defined network (SDN) controller, or other network element configured to manage network traffic transmitted through the service function chaining architecture 100 from the traffic source 104 to the traffic destination 114.

The traffic source 104 may store or be configured to obtain media and/or content such as, for example, images, videos, data files, etc. The traffic source 104 may transmit the media and/or content in the form of individual packets that, when assembled, represent the media or content. The traffic source 104 may be, for example, a server, router, gateway, or other network element configured to provide or transmit packets.

The traffic source 104 is operably coupled to one of the network devices 106. The network device 106 may be, for example, a switch, router, or other network element configured to receive, process, and transmit packets. The network device 106 may be referred to as a service function forwarder (SFF). As shown, the network device 106 may have the classifier 108 implemented thereon. In other circumstances, the classifier 108 may be disposed on a device separate from the network device 106. In addition, in some cases one classifier 108 may be shared by several network devices 106.

The classifier 108 may be, for example, software installed on the network device 106. In some cases, the classifier 108 is software installed on the network device 106 by, or at the direction of, the service chain orchestrator 102. Because the service chain orchestrator 102 is operably coupled to the network device 106, the service chain orchestrator 102 is able to configure and re-configure the classifier 108 as needed.

The classifier 108 is configured to determine which service function 112 or which service functions 112 should be applied to each packet received by the network device 106. In other words, the classifier 108 selects the packet flows to be serviced by the service chain and determines how to route the packets between the service nodes 110. The classifier 108 is able to do this by, for example, adding a service chain header to each incoming packet. The information in the packet header indicates to the network devices 106 which service functions are to be applied to each packet and the network device 106 forwards the packet accordingly. For example, the network device 106 may transmit the packet to the particular service node 110 having the service function or functions to be applied to the packet based on the information in the packet header.

The service node 110 is operably coupled to one of the network devices 106. The service node 110 may be, for example, a hardware application or a software module running on a virtual machine (VM). In addition, the service node 110 may be, for example, a data center. As shown, the service node 110 includes a variety of services functions 112 (a.k.a., service function instances) of a different type or of different functionalities. For example, one of the service nodes 110 includes an intrusion detection service (IDS), an intrusion protection service (IPS), a firewall (FW), and network address translation (NAT) function. Another of the services nodes 110 includes a cache, a load balancer (LB), a Quality of Service (QoS) function, a wide area network (WAN) optimizing controller (WOC), and a virtual private network (VPN) function. Those skilled in the art will appreciate that other service functions 112 may be found on other service nodes 110.

In the service function chaining architecture 100, service functions 112 found on the service nodes 110 are implemented sequentially. Because the service functions 112 are implemented in order, the service functions 112 form a service function chain. Each service function 112 applies a treatment to packets arriving at the service node 110 and then the packets are forwarded onward to the next service node 110 or toward the traffic destination 114 if no more services nodes 110 remain. For example, a packet arriving at the first service node 110 may have an IDS applied, then an IPS applied, then the FW applied, and then the NAT applied. A packet arriving at the second service node 110 may be subjected to the cache function, the LB function, the QoS function, the WOC function, and then the VPN function in that order. After all of the service functions 112 have been applied, the packet may be transmitted toward the traffic destination 114.

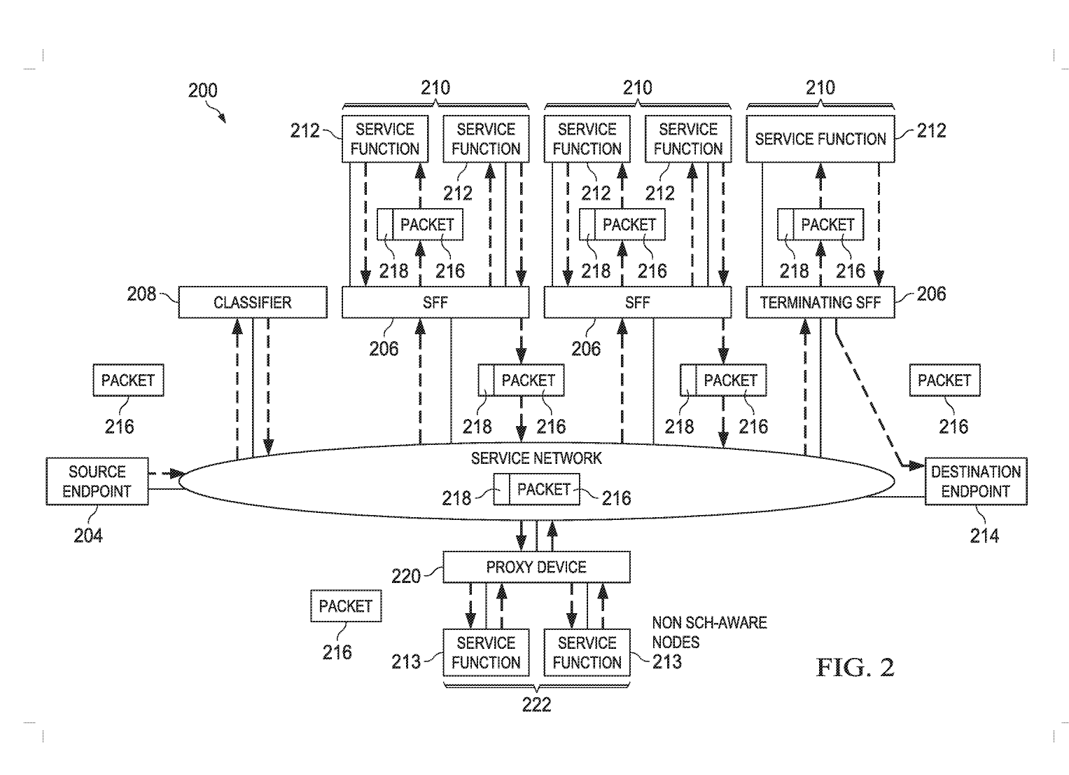

FIG. 2 is a schematic diagram illustrating the flow of a packet 216 (as shown by dashed lines) through a service function chaining architecture 200. The service function chaining architecture 200 of FIG. 2 and its components are similar to the service function chaining architecture 100 of FIG. 1 and its components. In that regard, the service chaining architecture 200 of FIG. 2 includes a traffic source 204, network devices 206, classifiers 208, services nodes 210 containing one or more service functions 212, and a traffic destination 214.

When the classifier 208 receives one of the packets 216 from the traffic source 204, the classifier 208 adds a service chain header (SCH) 218 to the packet 216. As shown, the service chain header 218 is prepended to the packet 216. The service chain header 218 includes, among other information, a chain path identifier. The chain path identifier identifies the particular service chain to which the packet 216 belongs.

Each network device 206, which may be referred to as a service function forwarder, uses the chain path identifier in the service chain header 218 of the packet 216 to select one of the service functions 212 in the service node 210 attached to the network device 206. The network device 206 then routes the packet 216 to the service function 212 that was selected so that the particular service function 212 may be applied to the packet 216. After treatment has been applied to the packet 216 by the particular service function 212, the packet 216 is returned to the network device 206. The network device 206 then forwards the treated packet 216 to the next service function 212 in the service node 210. If all of the service functions 212 in the service node 210 have treated the packet 216, the network device 206 forwards the packet 216 on to the next network device 206 along the service chain.

In some circumstances, the packet 216 may be routed to a proxy device 220 attached to a non-service chain aware node 222. When this occurs, the proxy device 220 removes the service chain header 218 from the packet 216 and sends the packet 216 to one of the non-service chain aware service functions 213 in the service node 222. After treatment has been applied to the packet 216 by the non-service chain aware service function 213, the packet 216 is returned to the proxy device 220. The proxy device 220 then forwards the treated packet 216 on to the next non-service chain aware service function 213 in service node 222 for further treatment. Because the proxy device 220 has removed the service chain header 218 from the packet 216, the proxy device 220 selects non-service chain aware service functions 213 in a manner that does not rely on any chain path identifier in the service chain header 218 of the packet 216.

After the packet 216 has been treated by each service function 212 and/or non-service chain aware service function 213 in the service function chain, the final network device 206 removes the service chain header 218 from the packet 216 and routes the packet to the traffic destination 214. The final network device 206 may be referred to as the terminating service function forwarder.

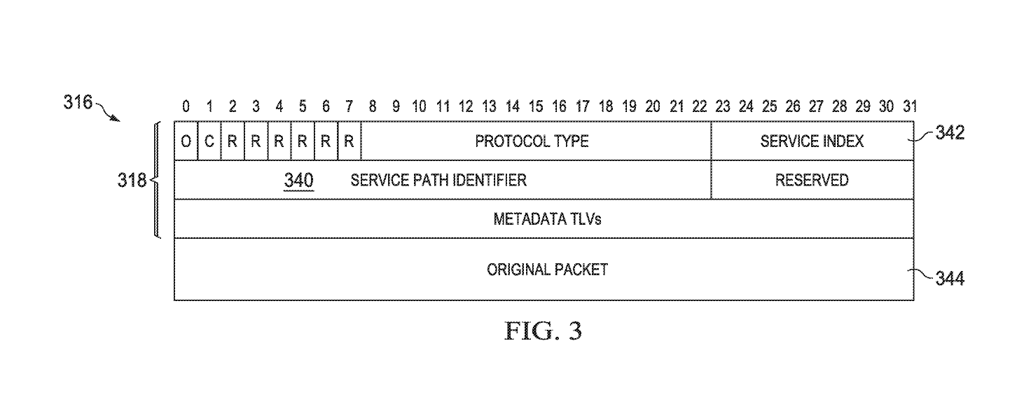

FIG. 3 is a schematic diagram of a packet 316 having a service chain header 318 added to an original packet 344 received from a traffic source (e.g., traffic source 104, 204). The packet 316 and service chain header 318 are similar to the packet 216 and service chain header 218 of FIG. 2. The service chain header 318 includes, among other things, a chain path identifier 340 and a service index 342. The chain path identifier 340, which may be referred to as a service path identifier, is a field in the service chain header 318. The chain path identifier 340 may include, for example, an identifier that indicates which service function chain should be applied to the packet 316. For example, if the chain path identifier 340 is the number 0010, the network device receiving the packet 316 recognizes that the packet 316 should be sequentially treated by a firewall and then a network address translation. As another example, if the chain path identifier 340 is the number 1011, the network device receiving the packet 316 recognizes that the packet 316 should be sequentially treated by a firewall, then a load balancer, then a quality of service function.

The service index 342 in the service chain header 318 of the packet 316 indicates, for example, the number of treatments or functions that will be applied to the packet to complete the service chain. The service index 342 is decremented each time one of the service functions is applied to the packet. When the service index 342 reaches zero or some other threshold, any network device handling the packet recognizes that all of the service functions have been applied to the packet 316 and the service chain has been exhausted. In practical applications, the packet 316 may contain other fields (e.g., Protocol Type, Reserved, etc.) as would be recognized by one skilled in the art. However, for the sake of brevity, these other fields are not discussed in detail herein.

As the traffic load varies through a service node (e.g., service node 110, 210), there is a need to dynamically vary the number of service functions (e.g., service functions 112, 212) used to apply treatment to traffic that transits the service chains. This ensures that sufficient processing capacity is available to provide the desired service treatment and that the individual service functions are not overloaded. Unfortunately, the service function architectures 100, 200 of FIGS. 1-2 are unable to meet this need.

Disclosed herein is a service function architecture that allows for more efficient scaling of service functions in a service chain. As will be more fully explained below, service functions having an equivalent functionality or type (e.g., all firewalls, all NATs, etc.) are organized together as a service function group (SFG). Because the service functions are processed together as a group of service functions having an equivalent functionality or type, a load distribution function (LDF) on an upstream node has the ability to dynamically vary the number of service functions used to apply treatment to packets that transit the service chain. As such, scaling of service functions is significantly improved.

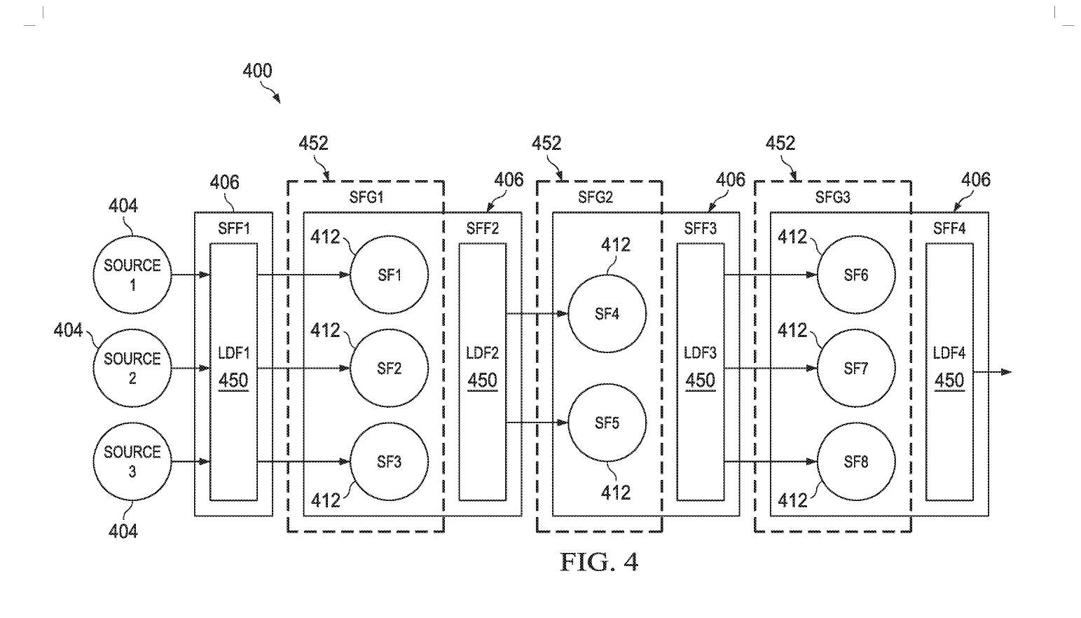

FIG. 4 is an embodiment of a service function chaining architecture 400. The service function chaining architecture 400 shares some similarities with the service function chaining architectures 100, 200 of FIGS. 1-2. For example, the service function chaining architecture 400 includes traffic sources 404 and network devices 406 similar to the traffic sources 104, 204 and the network devices 106, 206 of FIGS. 1-2. However, each of the network devices 406 also includes a load distribution function (LDF) 450, the operation of which will be more fully described below.

For purposes of discussion and clarity, the network device 406 immediately downstream of the traffic sources 404 in FIG. 4 is referred to as a first service function forwarder and is labeled accordingly as SFF1. As shown, SFF1 implements the first load distribution function 450 labeled LDF1. The network device 406 immediately downstream of SFF1 is referred to as a second service function forwarder and is labeled accordingly as SFF2. SFF2 implements the second load distribution function 450 labeled LDF2. Likewise, the network device 406 immediately downstream of SFF2 is referred to as a third service function forwarder and is labeled accordingly as SFF3, and the network device 406 immediately downstream of SFF3 is referred to as a fourth service function forwarder and is labeled accordingly as SFF4. SFF3 implements the third load distribution function 450, labeled LDF3, and SFF4 implements the fourth load distribution function 450, labeled LDF4.

As shown, each LDF is associated with one of the service function groups 452. For example, LDF1 is associated with SFG1, LDF2 is associated with SFG2, and LDF3 is associated with SFG3. Notably, each LDF is disposed on a network device (e.g., node) upstream of the SFG associated with that LDF. For example, SFG1 is managed by LDF1 on the upstream network device labeled SFF1 even though SFG1 is disposed on SFF2. SFG2 is managed by LDF2 on the upstream network device labeled SFF2 even though SFG2 is disposed on SFF3. Likewise, SFG3 is managed by LDF3 on the upstream network device labeled SFF3 even though SFG3 is disposed on SFF4.

Each load distribution function 450 is configured with information about its corresponding service function group 452. In an embodiment, each load distribution function 450 knows the address of the downstream network device 406 in order to reach the service functions 412 in its corresponding service function group 452. In an embodiment, each load distribution function 450 determines or is provided with a relative weighting to use for each service function 412 in the service function group 452. In an embodiment, each load distribution function 450 includes a hashing algorithm used to distribute packets equitably, equally, according to the relative weighting, or otherwise to the various service functions 412 in the service function group 452. In an embodiment, each load distribution function 450 is aware of the fields in the packets that are used for hashing. As will be more fully explained below, each load distribution function 450 also knows which type of service function selector is to be used.

When the network device 406 labeled SFF1 receives a packet from one of the traffic sources 404, the load distribution function 450 labeled LDF1 on the upstream network device 406 labeled SFF1 determines whether the service function 412 labeled SF1, SF2, or SF3 in the service function group 452 labeled SFG1 on the downstream network device 406 labeled SFF2 will treat the packet. As noted above, the service functions 412 labeled SF1, SF2, and SF3 in the service function group 452 labeled SFG1 have an equivalent functionality. For example, each of SF1, SF2, and SF3 is a firewall.

Because a load distribution function 450 on an upstream network device 406 is used to select a service function 412 of a same type from within a service function group 452 on a downstream network device 406, improved scaling and dynamic load balancing may be achieved. For example, if the traffic load increases an additional service function 412 of equivalent functionality (e.g., another firewall) may be added to the service function group 452 labeled SFG1. The addition of a service function to a service function group is referred to as a scale-out operation. Conversely, if the traffic load decreases a service function 412 may be removed from the service function group 452 labeled SFG1. The removal of a service function from a service function group is referred to as a scale-in operation. Using the scale-out and scale-in operations to add and remove service functions of an equivalent type to a service function group, any increase or decrease in the amount of traffic may be easily handled to improve scaling and dynamic load balancing.

Still referring to FIG. 4, after the packet has been treated by one of the service functions 412 labeled SF1, SF2, and SF3, the load distribution function 450 labeled LDF2 on the network device 406 labeled SFF2 determines whether the service function 412 labeled SF4 or SF5 in the service function group 452 labeled SFG2 on the network device 406 labeled SFF3 will treat the packet. The service functions 412 labeled SF4 and SF5 in the service function group 452 labeled SFG2 have an equivalent functionality. For example, each of SF4 and SF5 is a network address translator. If traffic increases, additional service functions 412 may be added to the service function group 452 labeled SFG2. If traffic decreases, service functions 412 may be removed from the service function group 452 labeled SFG2.

After the packet has been treated by one of the service functions 412 labeled SF4 and SF5, the load distribution function 450 labeled LDF3 on the network device 406 labeled SFF3 determines whether the service function 412 labeled SF6, SF7, or SF8 in the service function group 452 labeled SFG3 on the network device 406 labeled SFF4 will treat the packet. The service functions 412 labeled SF6, SF7, and SF8 in the service function group 452 labeled SFG3 have an equivalent functionality. For example, each of SF6, SF, 7, and SF8 is an intrusion detection service. If traffic increases, additional service functions 412 may be added to the service function group 452 labeled SFG3. If traffic decreases, service functions 412 may be removed from the service function group 452 labeled SFG3. The process continues in this manner until the terminating network device 406 is reached. The packet is then routed to the traffic destination.

In an embodiment, each load distribution function 450 is configured with an address of the downstream network device 106 having the service function group 452 associated with the load distribution function 450. That way, the upstream load distribution function 450 is able to reach the service functions 412 on the downstream network device 406. Those skilled in the art will appreciate that each load distribution function 450 may be able to reach the service functions 412 on a downstream network device 406 in a variety of other manners upon review of this disclosure.

In an embodiment, one or more of the load distribution function 450 is configured with a relative weighting for each of the service functions 412 on the downstream network device 406 associated with the load distribution function 450. For example, the service function 412 labeled SF1 may have a forty percent weighting, SF2 may have a thirty percent weighting, and SF3 may have a twenty percent weighting.

In an embodiment, one or more of the load distribution function 450 is configured with a hashing algorithm and is configured to recognize fields in the packet to be used for hashing. For example, the load distribution function 450 may hash one or more fields in a packet header in order to select which of the service functions 412 in the service function group 452 to select.

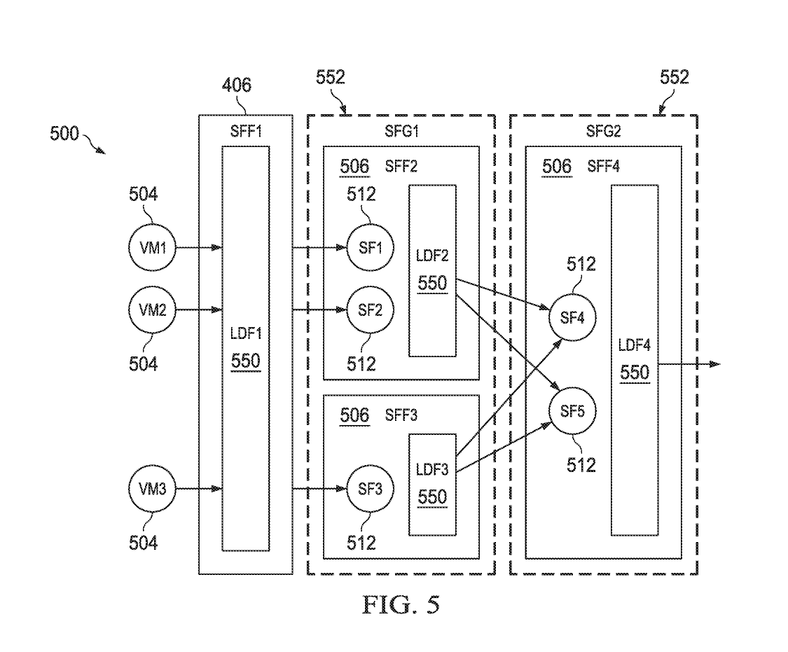

FIG. 5 is another embodiment a service function chaining architecture 500. The service function chaining architecture 500 is similar to the service function chaining architecture 400 of FIG. 4. For example, the service function chaining architecture 500 includes traffic sources 504, network devices 506, load distribution functions 550, and service function groups 552 similar to the traffic sources 404, network devices 406, load distribution functions 450, and service function groups 452 of FIG. 4. However, as shown in FIG. 5 the service function group 552 labeled SFG1 is spread across the two network devices 506 labeled SFF2 and SFF3. As such, the service functions 512 labeled SF1 and SF2 are disposed on the network device 506 labeled SFF2 and the service function 512 labeled SF3 is disposed on the network device 506 labeled SFF3. In such a configuration, the load distribution function 550 on the upstream network device 506 labeled SFF1 determines which of service functions 512 to send the packet to as well as which network device 506 the selected service function 512 resides on.

In an embodiment, the load distribution function 550 labeled LDF2 and the load distribution function 550 labeled LDF3 are configured with the same parameters. As such, the load distribution function 550 labeled LDF2 and the load distribution function 550 labeled LDF3 are able to cooperatively send packets to the service functions 512 labeled SF4 and SF5 on the downstream network device 506 labeled SFF4. In an embodiment, the load distribution function 550 labeled LDF2 and the load distribution function 550 labeled LDF3 may be in communication with each other to facilitate the shared use of the service functions 512 labeled SF4 and SF5.

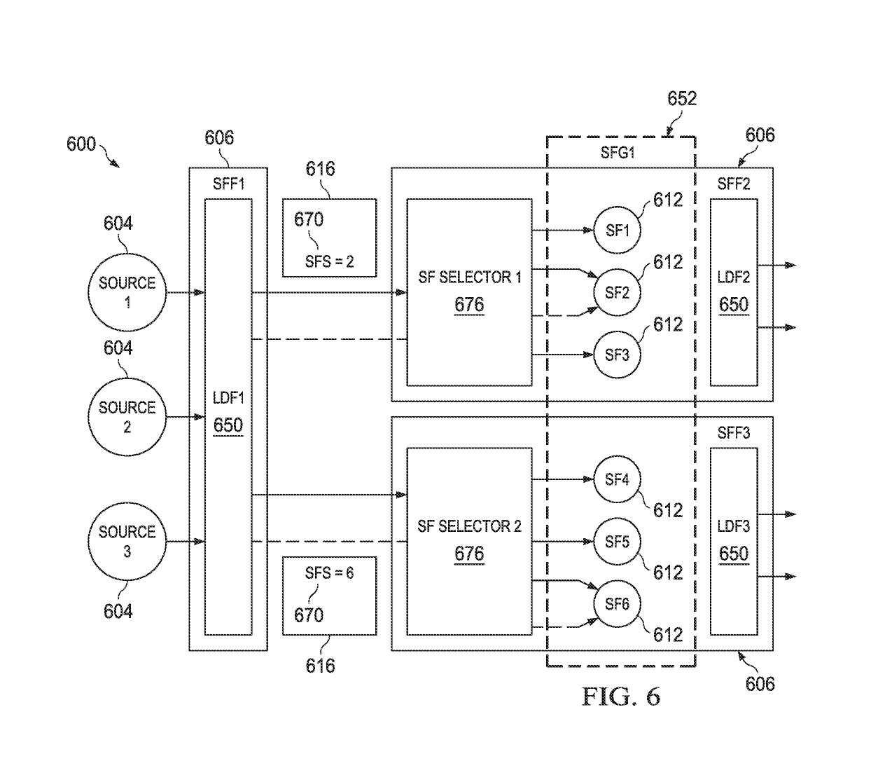

FIG. 6 is another embodiment of a service function chaining architecture 600. The service function chaining architecture 600 is similar to the service function chaining architecture 500 of FIG. 5. For example, the service function chaining architecture 600 includes traffic sources 604, network devices 606, load distribution functions 650, and a service function group 652 similar to the traffic sources 504, network devices 506, load distribution functions 550, and service function groups 552 of FIG. 5. However, as shown in FIG. 6 the load distribution function 650 upstream of the service function group 652 adds a service function selector 670 to the packet 616. The service function selector 670, which may also be referred to as a tag, is utilized to determine the appropriate service function 612 in downstream network devices 606 from the service function group 652 labeled SFG1, which is some cases includes several network devices 606.

As shown in FIG. 6, the load distribution function 650 on the network device 606 labeled SFF1 adds the service function selector 670 to the packet 616. In an embodiment, the load distribution function 650 uses the destination media access control (MAC) address of the packet 606 as the service function selector 670. In this case the destination media access control (MAC) address of the packet 606 is set to that of the ingress interface of the next service function 612. In an embodiment, the load distribution function 650 adds metadata to the service chain header of the packet 616 that may be used by the downstream network device 606 to determine the service function 612 that has been selected.

In an embodiment, the downstream network device 606 labeled SFF2 receives the packet 616 indicating that the service function selector 670 is equal to two (SFS=2). When the packet 616 is received, a service function selector unit 676 on the network device 606 labeled SFF2 determines that the packet 616 should be routed to the service function 612 labeled SF2 based on the service function selector 670 with the value of two. Likewise, when the packet 616 is received, a service function selector unit 676 on the network device 606 labeled SFF3 determines that the packet 616 should be routed to the service function 612 labeled SF6 based on the service function selector 670 with the value of six. In other words, each service function selector unit 676 uses the service function selector 670 in the received packet 616 to steer the packet 616 to the correct service function 612. In an embodiment, the service function selector unit 676, which may also be referred to as a service function selector function, may be implemented as software, hardware, or a combination thereof As shown in FIG. 6, the service function selector unit 676 labeled SF Selector 1 is disposed on the network device 606 labeled SFF2, and the service function selector unit 676 labeled SF Selector 2 is disposed on the network device 606 labeled SFF3.

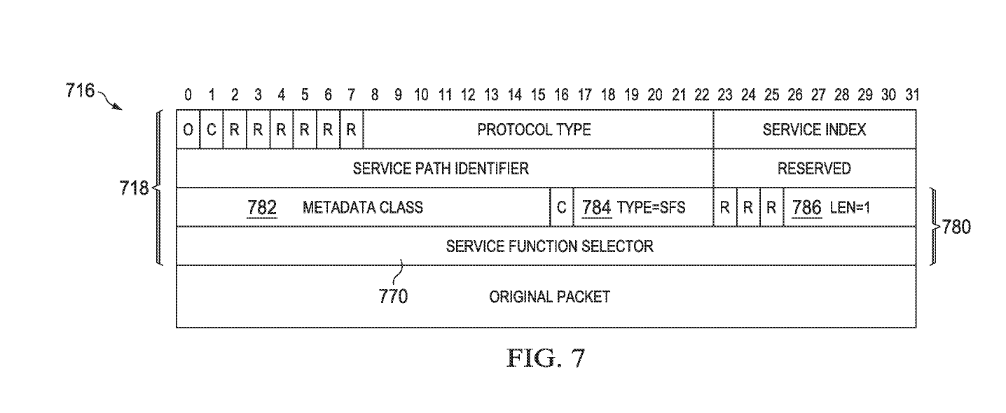

FIG. 7 is a schematic diagram of an embodiment of a packet 716 having a service chain header 718 containing a service function selector 770. The packet 716 and service chain header 718 are similar to the packet 316 and service chain header 318 of FIG. 3. However, unlike the chain path identifier 340 of FIG. 3 that identifies the service function chain to be applied, the packet 716 includes the service function selector 770 used to select one of a plurality of service functions having a same type from within a service function group on a downstream service function forwarder node to process the packet as described above with regard to FIG. 6.

In an embodiment, the service function selector 770 in the service chain header 718 of the packet 716 of FIG. 7 is disposed within a metadata type-length-value (TLV) field 780. The metadata class field 782 and the type =SFS field 784 represent the “type” in the TLV field 780 and the length field 786 represents the “length” in the TLV field 780. In addition, the service function selector 770 field represents the “value” in the TLV field 780.

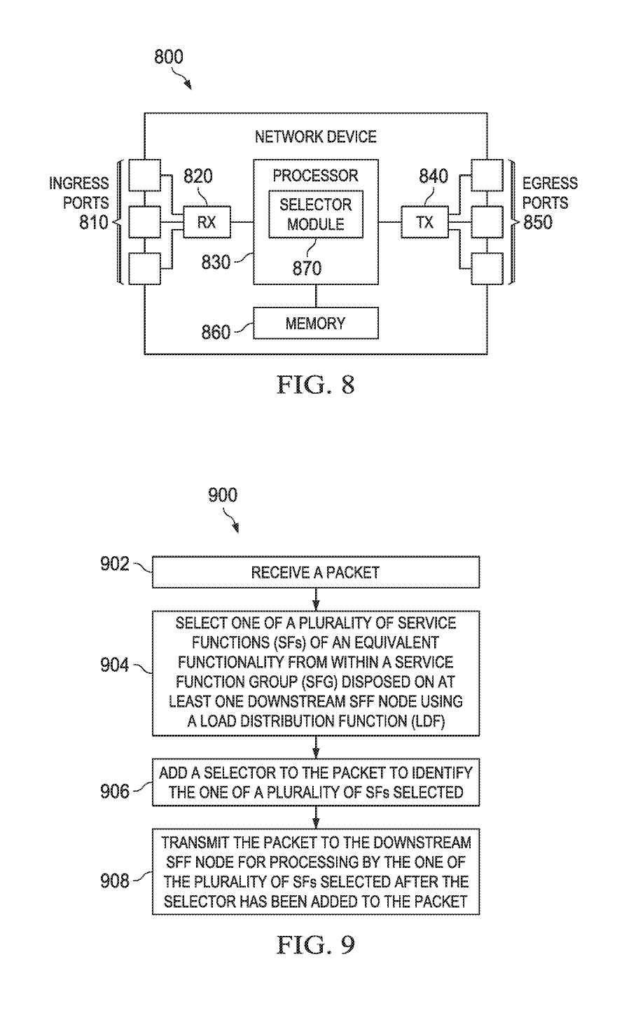

FIG. 8 is a schematic diagram of a network device 800 according to an embodiment of the disclosure. The device 800 is suitable for implementing the components described herein (e.g., the network devices 406, 506, 606 of FIGS. 4-6. The device 800 comprises ingress ports 810 and receiver units (Rx) 820 for receiving data; a processor, logic unit, or central processing unit (CPU) 830 to process the data; transmitter units (Tx) 840 and egress ports 850 for transmitting the data; and a memory 860 for storing the data. The device 800 may also comprise optical-to-electrical (OE) components and electrical-to-optical (EO) components coupled to the ingress ports 810, the receiver units 820, the transmitter units 840, and the egress ports 850 for egress or ingress of optical or electrical signals.

The processor 830 is implemented by hardware and software. The processor 830 may be implemented as one or more CPU chips, cores (e.g., as a multi-core processor), field-programmable gate arrays (FPGAs), application specific integrated circuits (ASICs), and digital signal processors (DSPs). The processor 830 is in communication with the ingress ports 810, receiver units 820, transmitter units 840, egress ports 850, and memory 860. The processor 830 comprises a selector module 870. The selector module 870 implements the disclosed embodiments described above. For instance, the selector module 870 implements the load distribution functions 450, 550, 650 of FIGS. 4-6 or the service function selector unit 676 of FIG. 6. The inclusion of the selector module 870 therefore provides a substantial improvement to the functionality of the device 800 and effects a transformation of the device 800 to a different state. Alternatively, the selector module 870 is implemented as instructions stored in the memory 860 and executed by the processor 830.

The memory 860 comprises one or more disks, tape drives, and solid-state drives and may be used as an over-flow data storage device, to store programs when such programs are selected for execution, and to store instructions and data that are read during program execution. The memory 860 may be volatile and non-volatile and may be read-only memory (ROM), random-access memory (RAM), ternary content-addressable memory (TCAM), and static random-access memory (SRAM).

FIG. 9 is an embodiment of a method 900 of distributed load balancing implemented on an upstream network device (e.g., the upstream network device 606 labeled SFF1 in FIG. 6). In block 902, the upstream network device receives a packet. In an embodiment, the packet is similar to the packet 216, 316, 616, 717 in FIGS. 2-3 and 6-7. In block 904, one of a plurality of service functions (e.g., service function 612) of an equivalent functionality (e.g., all firewalls) from within a service function group (e.g., service function group 652 labeled SFG1 in FIG. 6) is disposed on at least one downstream SFF node (e.g., network device 606 labeled SFF2 in FIG. 6) is selected using a load distribution function (e.g., load distribution function 650 labeled LDF1 on the upstream network device 406 labeled SFF1 in FIG. 6).

In block 906, a selector (e.g., selector 670 in FIG. 6) is added to the packet (e.g., packet 616 in FIG. 6) to identify the one of a plurality of SFs selected. In block 908, the packet is transmitted to the downstream SFF node (e.g., network device 606 labeled SFF2 in FIG. 6) for processing by the one of the plurality of SFs selected after the selector has been added to the packet. The process may be repeated for each successive downstream node (or nodes) that contain a service function group until the packet has been fully treated and the traffic destination has been reached.

In an embodiment, the steering of chain traffic to the service functions in a data-plane is handled by virtual switches in a virtualized network environment such as, for example, a data center. Therefore, the inventive concepts disclosed herein may have particular applicability to OpenStack platform. OpenStack is a free and open-source software platform for cloud computing, mostly deployed as an infrastructure-as-a-service (IaaS). The inventive concepts disclosed herein may be implemented using Openvswitch (OVS), which is described in the document entitled “OVS Driver and Agent Workflow” found at http://docs.openstack.org/developer/networking-sfc/ovs_driver_and_agent_workflow.html#flow-tables-and-flow-rules, which is incorporated herein by reference. In an embodiment, the inventive concepts disclosed herein are implemented using the Network Service Header (NSH) TLV disclosed in the Internet Engineering Task Force (IETF) document draft-quinn-sfc-nsh-tiv-02.txt entitled “Network Service Header TLVs,” dated Oct. 21, 2016, which is incorporated herein by reference.

The inventive concepts disclosed herein provide numerous advantages. For example, dynamic scaling of service functions used in service chains is provided. In addition, fine-grained scaling on individual service function groups is allowed at each hop in a service function chain. Also, direct delivery of service function chain traffic to the service functions in a service function group is permitted without the need for a two-stage load distribution function. Moreover, service function chain traffic may be delivered to the correct service function when multiple service functions in a service function group are attached to the same service function forwarder.

The inventive concepts disclosed herein differ from other less flexible solutions that only allow scaling operations to be controlled from a centralized service orchestrator or at an ingress classifier. In addition, the scale-out and scale-in operations are done on individual SFGs at each hop in the service chain. In addition, direct delivery of the SFC traffic from the upstream SFF to the downstream SFF without the need for multiple stages of load distribution is provided. Moreover, there is currently no solution for the case of a SFC that has a SFF attached to multiple SFs in the same SFG. The IETF draft for the NSH does not provide a solution for this. See, for example, the IETF document draft-ietf-sfc-nsh-10.txt entitled “Network Service Header,” dated Feb. 24, 2015.

In addition, the inventive concepts disclosed herein allow dynamic, flexible scaling of service functions in service function chains. This offers a significant technical advantage when implemented in service chain solutions for network deployments such as, for example, data center, mobile G-interface local area network (Gi LAN), and carrier networks.

An upstream service function forwarder (SFF) node comprising means for receiving a packet, means for processing coupled to the means for receiving and configured to implement a load distribution function (LDF), wherein the LDF is configured to select one of a plurality of service functions (SFs) of a same type on a downstream SFF node to process the packet, and means for transmitting coupled to the means for processing and configured to transmit the packet to the downstream SFF node for processing by the one of the plurality of SFs selected.

A downstream service function forwarder (SFF) node comprising means for receiving a packet from an upstream SFF node, means for processing coupled to the means for receiving and configured to parse the packet to identify one of a plurality of SFs of an equivalent functionality from within a service function group (SFG) selected by a load distribution function (LDF) of the upstream SFF, and apply the one of a plurality of SFs identified to the packet, and means for transmitting coupled to the means for processing and configured to transmit the packet after the one of the plurality of SFs has been applied to the packet.

A method of distributed load balancing implemented on an upstream service function forwarder (SFF) node using means for receiving a packet, means for selecting one of a plurality of service functions (SFs) of an equivalent functionality from within a service function group (SFG) disposed on at least one downstream SFF node using a load distribution function (LDF), means for adding a selector to the packet to identify the one of a plurality of SFs selected, and means for transmitting the packet to the downstream SFF node for processing by the one of the plurality of SFs selected after the selector has been added to the packet.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. An upstream service function forwarder (SFF) node, comprising:
a receiver configured to receive a packet;
a processor operably coupled to the receiver and configured to implement a load distribution function (LDF), wherein the LDF is configured to select one of a plurality of service functions (SFs) of a same type on a downstream SFF node to process the packet; and
a transmitter operably coupled to the processor and configured to transmit the packet to the downstream SFF node for processing by the one of the plurality of SFs selected.

2. The upstream SFF of claim 1, wherein the upstream SFF node is immediately upstream of the downstream SFF node.

3. The upstream SFF of claim 1, wherein the plurality of SFs is disposed within a service function group (SFG) on the downstream SFF node, and wherein the SFG extends over the downstream SFF node and at least one additional downstream SFF node.

4. The upstream SFF of claim 3, wherein the processor is configured to add a selector to the packet to identify the one of the plurality of SFs selected on the downstream SFF node.

5. The upstream SFF of claim 4, wherein the processor is configured to add the selector to a destination media access control (MAC) address of the packet.

6. The upstream SFF of claim 4, wherein the processor is configured to add metadata to a service chain header of the packet that may be used by the downstream SFF node to determine the one of the plurality of SFs selected.

7. The upstream SFF of claim 4, wherein the selector is added to a type-length-value (TLV) field in a service chain header of the packet.

8. The upstream SFF of claim 1, wherein the plurality of SFs is disposed within a service function group (SFG) on the downstream SFF node, and wherein the LDF is configured with an address of the downstream SFF node used to reach the plurality of SFs in the SFG.

9. The upstream SFF of claim 1, wherein the plurality of SFs is disposed within a service function group (SFG) on the downstream SFF node, and wherein the LDF is configured with a relative weighting of each SF in the plurality of SFs in the SFG.

10. The upstream SFF of claim 1, wherein the LDF is configured with a hashing algorithm and is configured to recognize fields in the packet to be used for hashing.

11. The upstream SFF of claim 1, wherein the upstream SFF node is one of a switch and a router.

12. A downstream service function forwarder (SFF) node, comprising:
a receiver configured to receive a packet from an upstream SFF node;
a processor operably coupled to the receiver and configured to:
parse the packet to identify one of a plurality of SFs of an equivalent functionality from within a service function group (SFG) selected by a load distribution function (LDF) of the upstream SFF; and
apply the one of a plurality of SFs identified to the packet; and
a transmitter operably coupled to the processor and configured to transmit the packet after the one of the plurality of SFs has been applied to the packet.

13. The downstream SFF node of claim 12, wherein the SFG encompasses the downstream SFF node and at least one additional downstream SFF node.

14. The downstream SFF node of claim 12, wherein the packet contains a selector that identifies the one of the plurality of SFs selected, and wherein the selector is included within a destination media access control (MAC) address of the packet or metadata in a service chain header of the packet.

15. The downstream SFF node of claim 12, wherein the packet contains a selector used by the downstream SFF node to determine a next one of the SFs from the plurality of SFs.

16. The downstream SFF node of claim 12, wherein each SF in the plurality of SFs in the SFG has been assigned a relative weighting by the LDF of the upstream SFF node.

17. A method of distributed load balancing implemented on an upstream service function forwarder (SFF) node, comprising:
receiving a packet;
selecting one of a plurality of service functions (SFs) of an equivalent functionality from within a service function group (SFG) disposed on at least one downstream SFF node using a load distribution function (LDF);
adding a selector to the packet to identify the one of a plurality of SFs selected; and
transmitting the packet to the downstream SFF node for processing by the one of the plurality of SFs selected after the selector has been added to the packet.

18. The method of claim 17, further comprising considering a relative weighting of each SF in the SFG prior to selecting the one of a plurality of SFs.

19. The method of claim 17, further comprising hashing a field in the packet in order to select the one of a plurality of SFs, and wherein the selector is added to a type-length-value (TLV) field in a service chain header of the packet.

20. The method of claim 16, wherein the selector is a SF Selector (SFS) added to a service chain header of the packet.
